(19) United States
(12) Patent Application Publication
(10) Pub. No.: US 2016/0359695 A1
(43) Pub. Date: Dec. 8, 2016

(54) NETWORK BEHAVIOR DATA COLLECTION AND ANALYTICS FOR ANOMALY DETECTION

(71) Applicant: CISCO TECHNOLOGY, INC., San Jose, CA (US)

(72) Inventors: Navindra Yadav, Cupertino, CA (US); Ellen Scheib, Mountain View, CA (US); Rachita Agasthy, Sunnyvale, CA (US)

(73) Assignee: CISCO TECHNOLOGY, INC., San Jose, CA (US)

(21) Appl. No.: 15/090,930

(22) Filed: Apr. 5, 2016

Related U.S. Application Data
(60) Provisional application No. 62/171,044, filed on Jun. 4, 2015.

(51) Int. Cl. H04L 12/26; G06N 99/00

(52) U.S. Cl. CPC H04L 43/04; H04L 43/12; G06N 99/005

(57) ABSTRACT

In one embodiment, a method includes receiving at an analytics module operating at a network device, network traffic data collected from a plurality of sensors distributed throughout a network and installed in network components to obtain the network traffic data from packets transmitted to and from the network components and monitor network flows within the network from multiple perspectives in the network, processing the network traffic data at the analytics module, the network traffic data comprising process information, user information, and host information, and identifying at the analytics module, anomalies within the network traffic data based on dynamic modeling of network behavior. An apparatus and logic are also disclosed herein.

### STATEMENT OF RELATED APPLICATION

The present application claims priority from U.S. Provisional Application No. 62/171,044, entitled ANOMALY DETECTION WITH PERVASIVE VIEW OF NETWORK BEHAVIOR, filed on Jun. 4, 2015 (Attorney Docket No. CISCP1283+). The contents of this provisional application are incorporated herein by reference in its entirety.

### TECHNICAL FIELD

The present disclosure relates generally to communication networks, and more particularly, to anomaly detection.

### BACKGROUND

Big data is defined as data that is so high in volume and high in speed that it cannot be affordably processed and analyzed using traditional relational database tools. Typically, machine generated data combined with other data sources creates challenges for both businesses and their (IT) Information Technology organizations. With data in organizations growing explosively and most of that new data unstructured, companies and their IT groups are facing a number of extraordinary issues related to scalability, complexity, and security.

Anomaly detection is used to identify items, events, or traffic that exhibit behavior that does not conform to an expected pattern or data. Anomaly detection systems may, for example, learn normal activity and take action for behavior that deviates from what is learned as normal behavior. Conventional network anomaly detection typically occurs at a high level and is not based on a comprehensive view of network traffic when implemented with big data, thus resulting in a number of limitations.

### BRIEF DESCRIPTION OF THE FIGURES

FIG. 1 illustrates an example of a network in which embodiments described herein may be implemented.

FIG. 2 depicts an example of a network device useful in implementing embodiments described herein.

FIG. 3 illustrates a network behavior collection and analytics system for use in anomaly detection, in accordance with one embodiment.

FIG. 4 illustrates details of the system of FIG. 3, in accordance with one embodiment.

FIG. 5 is a flowchart illustrating an overview of anomaly detection with pervasive view of the network, in accordance with one embodiment.

FIG. 6 illustrates a process flow for anomaly detection, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving at an analytics module operating at a network device, network traffic data collected from a plurality of sensors distributed throughout a network and installed in network components to obtain the network traffic data from packets transmitted to and from the network components and monitor network flows within the network from multiple perspectives in the network, processing the network traffic data at the analytics module, the network traffic data comprising process information, user information, and host information, and identifying at the analytics module, anomalies within the network traffic data based on dynamic modeling of network behavior.

In another embodiment, an apparatus generally comprises an interface for receiving network traffic data collected from a plurality of sensors distributed throughout a network and installed in network components to obtain the network traffic data from packets transmitted to and from the network components and monitor network flows within the network from multiple perspectives in the network AND, a processor for processing the network traffic data from the packets, the network traffic data comprising process information, user information, and host information, and identifying at the network device, anomalies within the network traffic data based on dynamic modeling of network behavior.

In yet another embodiment, logic is encoded on one or more non-transitory computer readable media for execution and when executed operable to process network traffic data collected from a plurality of sensors distributed throughout a network and installed in network components to obtain the network traffic data from packets transmitted to and from the network components and monitor network flows within the network from multiple perspectives in the network, the network traffic data comprising process information, user information, and host information, and identify anomalies within the network traffic based on dynamic modeling of network behavior.

### EXAMPLE EMBODIMENTS

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Conventional anomaly detection occurs at a high level and does not check all traffic. Limitations include blacklist approaches instead of whitelists, limited scale (not pervasive), no dynamicity (reactive antivirus signatures and manually designed logic), and single viewpoint. Conventional technologies for detecting presence of malicious behavior in networks typically collect data from a single vantage point in the network and identify suspicious behavior at that point using specific (static) rules or signatures. Since conventional security systems are based on specific rules and signatures, these approaches are not generalized and are unable to identify novel but similar malicious activity. Moreover, with more domains producing a seemingly unending amount of data, machine learning techniques to categorize and make sense of data is of paramount importance.

The embodiments described herein are directed to the application of machine learning anomaly detection techniques to large-scale pervasive network behavior metadata. The anomaly detection system may be used, for example, to identify suspicious network activity potentially indicative of malicious behavior. The identified anomaly may be used for downstream purposes including network forensics, policy decision making, and enforcement, for example. Embodiments described herein (also referred to as Tetration Analytics) provide a big data analytics platform that monitors everything (or almost everything) while providing pervasive security. One or more embodiments may provide application dependency mapping, application policy definition, policy simulation, non-intrusive detection, distributed denial of service detection, data center wide visibility and forensics, or any combination thereof.

As described in detail below, network data is collected throughout a network such as a data center using multiple vantage points. This provides a pervasive view of network behavior, using metadata from every (or almost every) packet. One or more embodiments may provide visibility from every (or almost every) host, process, and user perspective. The network metadata is combined in a central big data analytics platform for analysis. Since information about network behavior is captured from multiple perspectives, the various data sources can be correlated to provide a powerful information source for data analytics.

The comprehensive and pervasive information about network behavior that is collected over time and stored in a central location enables the use of machine learning algorithms to detect suspicious activity. Multiple approaches to modeling normal or typical network behavior may be used and activity that does not conform to this expected behavior may be flagged as suspicious, and may be investigated. Machine learning allows for the identification of anomalies within the network traffic based on dynamic modeling of network behavior.

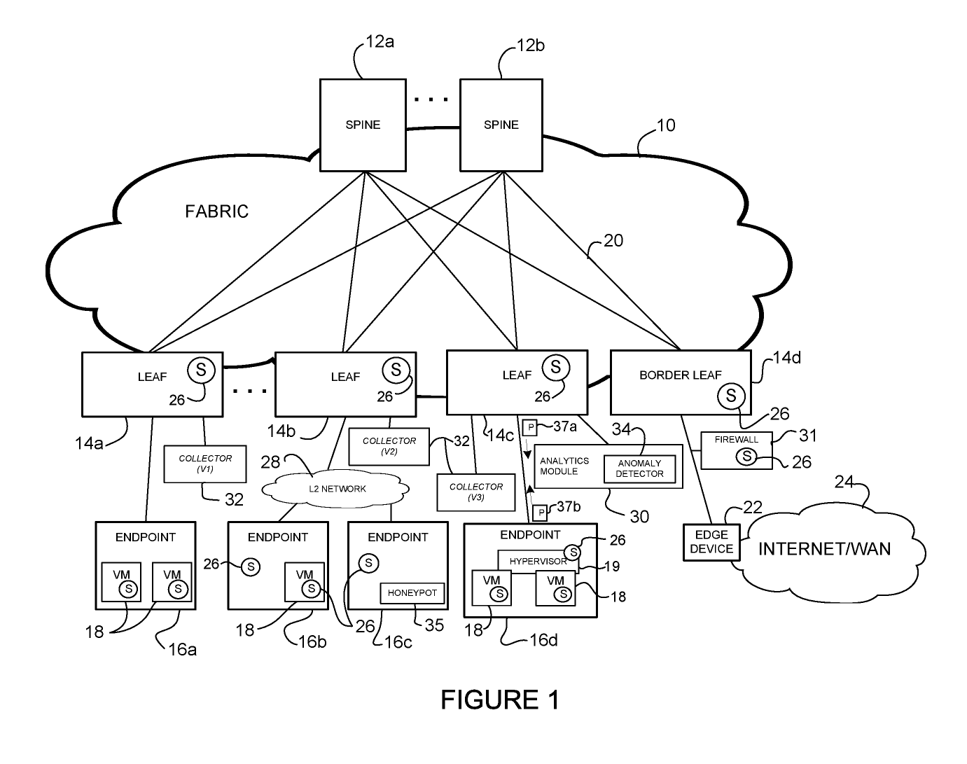

Referring now to the drawings, and first to FIG. 1, a simplified network in which embodiments described herein may be implemented is shown. The embodiments operate in the context of a data communication network including multiple network devices. The network may include any number of network devices in communication via any number of nodes (e.g., routers, switches, gateways, controllers, edge devices, access devices, aggregation devices, core nodes, intermediate nodes, or other network devices), which facilitate passage of data within the network. The nodes may communicate over one or more networks (e.g., local area network (LAN), metropolitan area network (MAN), wide area network (WAN), virtual private network (VPN), virtual local area network (VLAN), wireless network, enterprise network, corporate network, Internet, intranet, radio access network, public switched network, or any other network). Network traffic may also travel between a main campus and remote branches or any other networks.

In the example of FIG. 1, a fabric 10 comprises a plurality of spine nodes 12a, 12b and leaf nodes 14a, 14b, 14c, 14d. The leaf nodes 14a, 14b, 14c, may connect to one or more endpoints (hosts) 16a, 16b, 16c, 16d (e.g., servers hosting virtual machines (VMs) 18). The leaf nodes 14a, 14b, 14c, 14d are each connected to a plurality of spine nodes 12a, 12b via links 20. In the example shown in FIG. 1, each leaf node 14a, 14b, 14c, 14d is connected to each of the spine nodes 12a, 12b and is configured to route communications between the hosts 16a, 16b, 16c, 16d and other network elements.

The leaf nodes 14a, 14b, 14c, 14d and hosts 16a, 16b, 16c, 16d may be in communication via any number of nodes or networks. As shown in the example of FIG. 1, one or more servers 16b, 16c may be in communication via a network 28 (e.g., layer 2 (L2) network). In the example shown in FIG. 1, border leaf node 14d is in communication with an edge device 22 (e.g., router) located in an external network 24 (e.g., Internet/WAN (Wide Area Network)). The border leaf 14d may be used to connect any type of external network device, service (e.g., firewall 31), or network (e.g., layer 3 (L3) network) to the fabric 10.

The spine nodes 12a, 12b and leaf nodes 14a, 14b, 14c, 14d may be switches, routers, or other network devices (e.g., L2, L3, or L2/L3 devices) comprising network switching or routing elements configured to perform forwarding functions. The leaf nodes 14a, 14b, 14c, 14d may include, for example, access ports (or non-fabric ports) to provide connectivity for hosts 16a, 16b, 16c, 16d, virtual machines 18, or other devices or external networks (e.g., network 24), and fabric ports for providing uplinks to spine switches 12a, 12b.

The leaf nodes 14a, 14b, 14c, 14d may be implemented, for example, as switching elements (e.g., Top of Rack (ToR) switches) or any other network element. The leaf nodes 14a, 14b, 14c, 14d may also comprise aggregation switches in an end-of-row or middle-of-row topology, or any other topology. The leaf nodes 14a, 14b, 14c, 14d may be located at the edge of the network fabric 10 and thus represent the physical network edge. One or more of the leaf nodes 14a, 14b, 14c, 14d may connect Endpoint Groups (EGPs) to network fabric 10, internal networks (e.g., network 28), or any external network (e.g., network 24). EPGs may be used, for example, for mapping applications to the network.

Endpoints 16a, 16b, 16c, 16d may connect to network fabric 10 via the leaf nodes 14a, 14b, 14c. In the example shown in FIG. 1, endpoints 16a and 16d connect directly to leaf nodes 14a and 14c, respectively, which can connect the hosts to the network fabric 10 or any other of the leaf nodes. Endpoints 16b and 16c connect to leaf node 14b via L2 network 28. Endpoints 16b, 16c and L2 network 28 may define a LAN (Local Area Network). The LAN may connect nodes over dedicated private communication links located in the same general physical location, such as a building or campus.

WAN 24 may connect to leaf node 14d via an L3 network (not shown). The WAN 24 may connect geographically dispersed nodes over long distance communication links, such as common carrier telephone lines, optical lightpaths, synchronous optical networks (SONETs), or synchronous digital hierarchy (SDH) links. The Internet is an example of a WAN that connects disparate networks and provides global communication between nodes on various networks. The nodes may communicate over the network by exchanging discrete frames or packets of data according to predefined protocols, such as Transmission Control Protocol (TCP)/Internet Protocol (IP).

One or more of the endpoints may have instantiated thereon one or more virtual switches (not shown) for communication with one or more virtual machines 18. Virtual switches and virtual machines 18 may be created and run on each physical server on top of a hypervisor 19 installed on the server, as shown for endpoint 16d. For ease of illustration, the hypervisor 19 is only shown on endpoint 16d, but it is to be understood that one or more of the other endpoints having virtual machines 18 installed thereon may also comprise a hypervisor. Also, one or more of the endpoints may include a virtual switch. The virtual machines 18 are configured to exchange communication with other virtual machines. The network may include any number of physical servers hosting any number of virtual machines 18. The host may also comprise blade/physical servers without virtual machines (e.g., host 16c in FIG. 1).

The term ‘host’ or ‘endpoint’ as used herein may refer to a physical device (e.g., server, endpoint 16a, 16b, 16c, 16d) or a virtual element (e.g., virtual machine 18). The endpoint may include any communication device or component, such as a computer, server, hypervisor, virtual machine, container, process (e.g., running on a virtual machine), switch, router, gateway, host, device, external network, etc.

One or more network devices may be configured with virtual tunnel endpoint (VTEP) functionality, which connects an overlay network (not shown) with network fabric 10. The overlay network may allow virtual networks to be created and layered over a physical network infrastructure.

The embodiments include a network behavior data collection and analytics system comprising a plurality of sensors 26 located throughout the network, collectors 32, and analytics module 30. The data monitoring and collection system may be integrated with existing switching hardware and software and operate within an Application-Centric Infrastructure (ACI), for example.

In certain embodiments, the sensors 26 are located at components throughout the network so that all packets are monitored. For example, the sensors 26 may be used to collect metadata for every packet traversing the network (e.g., east-west, north-south). The sensors 26 may be installed in network components to obtain network traffic data from packets transmitted from and received at the network components and monitor all network flows within the network. The term ‘component’ as used herein may refer to a component of the network (e.g., process, module, slice, blade, server, hypervisor, machine, virtual machine, switch, router, gateway, etc.).

In some embodiments, the sensors 26 are located at each network component to allow for granular packet statistics and data at each hop of data transmission. In other embodiments, sensors 26 may not be installed in all components or portions of the network (e.g., shared hosting environment in which customers have exclusive control of some virtual machines 18).

The sensors 26 may reside on nodes of a data center network (e.g., virtual partition, hypervisor, physical server, switch, router, gateway, or any other network device). In the example shown in FIG. 1, the sensors 26 are located at server 16c, virtual machines 18, hypervisor 19, leaf nodes 14a, 14b, 14c, 14d, and firewall 31. The sensors 26 may also be located at one or more spine nodes 12a, 12b or interposed between network elements.

A network device (e.g., endpoints 16a, 16b, 16d) may include multiple sensors 26 running on various components within the device (e.g., virtual machines, hypervisor, host) so that all packets are monitored (e.g., packets 37a, 37b to and from components). For example, network device 16d in the example of FIG. 1 includes sensors 26 residing on the hypervisor 19 and virtual machines 18 running on the host.

The installation of the sensors 26 at components throughout the network allows for analysis of network traffic data to and from each point along the path of a packet within the ACI. This layered sensor structure provides for identification of the component (i.e., virtual machine, hypervisor, switch) that sent the data and when the data was sent, as well as the particular characteristics of the packets sent and received at each point in the network. This also allows for the determination of which specific process and virtual machine 18 is associated with a network flow. In order to make this determination, the sensor 26 running on the virtual machine 18 associated with the flow may analyze the traffic from the virtual machine, as well as all the processes running on the virtual machine and, based on the traffic from the virtual machine, and the processes running on the virtual machine, the sensor 26 can extract flow and process information to determine specifically which process in the virtual machine is responsible for the flow. The sensor 26 may also extract user information in order to identify which user and process is associated with a particular flow. In one example, the sensor 26 may then label the process and user information and send it to the collector 32, which collects the statistics and analytics data for the various sensors 26 in the virtual machines 18, hypervisors 19, and switches 14a, 14b, 14c, 14d.

As previously described, the sensors 26 are located to identify packets and network flows transmitted throughout the system. For example, if one of the VMs 18 running at host 16d receives a packet 37a from the Internet 24, it may pass through router 22, firewall 31, switches 14d, 14c, hypervisor 19, and the VM. Since each of these components contains a sensor 26, the packet 37a will be identified and reported to collectors 32. In another example, if packet 37b is transmitted from VM 18 running on host 16d to VM 18 running on host 16a, sensors installed along the data path including at VM 18, hypervisor 19, leaf node 14c, leaf node 14a, and the VM at node 16a will collect metadata from the packet.

The sensors 26 may be used to collect information including, but not limited to, network information comprising metadata from every (or almost every) packet, process information, user information, virtual machine information, tenant information, network topology information, or other information based on data collected from each packet transmitted on the data path. The network traffic data may be associated with a packet, collection of packets, flow, group of flows, etc. The network traffic data may comprise, for example, VM ID, sensor ID, associated process ID, associated process name, process user name, sensor private key, geo-location of sensor, environmental details, etc. The network traffic data may also include information describing communication on all layers of the OSI (Open Systems Interconnection) model. For example, the network traffic data may include signal strength (if applicable), source/destination MAC (Media Access Control) address, source/destination IP (Internet Protocol) address, protocol, port number, encryption data, requesting process, sample packet, etc. In one or more embodiments, the sensors 26 may be configured to capture only a representative sample of packets.

The system may also collect network performance data, which may include, for example, information specific to file transfers initiated by the network devices, exchanged emails, retransmitted files, registry access, file access, network failures, component failures, and the like. Other data such as bandwidth, throughput, latency, jitter, error rate, and the like may also be collected.

Since the sensors 26 are located throughout the network, the data is collected using multiple vantage points (i.e., from multiple perspectives in the network) to provide a pervasive view of network behavior. The capture of network behavior information from multiple perspectives rather than just at a single sensor located in the data path or in communication with a component in the data path, allows data to be correlated from the various data sources to provide a useful information source for data analytics and anomaly detection. For example, the plurality of sensors 26 providing data to the collectors 32 may provide information from various network perspectives (view V1, view V2, view V3, etc.), as shown in FIG. 1.

The sensors 26 may comprise, for example, software (e.g., running on a virtual machine, container, virtual switch, hypervisor, physical server, or other device), an application-specific integrated circuit (ASIC) (e.g., component of a switch, gateway, router, standalone packet monitor, PCAP (packet capture) module), or other device. The sensors 26 may also operate at an operating system (e.g., Linux, Windows) or bare metal environment. In one example, the ASIC may be operable to provide an export interval of 10 msecs to 1000 msecs (or more or less) and the software may be operable to provide an export interval of approximately one second (or more or less). Sensors 26 may be lightweight, thereby minimally impacting normal traffic and compute resources in a data center. The sensors 26 may, for example, sniff packets sent over its host Network Interface Card (NIC) or individual processes may be configured to report traffic to the sensors. Sensor enforcement may comprise, for example, hardware, ACI/standalone, software, IP tables, Windows filtering platform, etc.

As the sensors 26 capture communications, they may continuously send network traffic data to collectors 32 for storage. The sensors 26 may send their records to one or more of the collectors 32. In one example, the sensors may be assigned primary and secondary collectors 32. In another example, the sensors 26 may determine an optimal collector 32 through a discovery process.

In certain embodiments, the sensors 26 may preprocess network traffic data before sending it to the collectors 32. For example, the sensors 26 may remove extraneous or duplicative data or create a summary of the data (e.g., latency, packets, bytes sent per flow, flagged abnormal activity, etc.). The collectors 32 may serve as network storage for the system or the collectors may organize, summarize, and preprocess data. For example, the collectors 32 may tabulate data, characterize traffic flows, match packets to identify traffic flows and connection links, or flag anomalous data. The collectors 32 may also consolidate network traffic flow data according to various time periods.

Information collected at the collectors 32 may include, for example, network information (e.g., metadata from every packet, east-west and north-south), process information, user information (e.g., user identification (ID), user group, user credentials), virtual machine information (e.g., VM ID, processing capabilities, location, state), tenant information (e.g., access control lists), network topology, etc. Collected data may also comprise packet flow data that describes packet flow information or is derived from packet flow information, which may include, for example, a five-tuple or other set of values that are common to all packets that are related in a flow (e.g., source address, destination address, source port, destination port, and protocol value, or any combination of these or other identifiers). The collectors 32 may utilize various types of database structures and memory, which may have various formats or schemas.

In some embodiments, the collectors 32 may be directly connected to a top-of-rack switch (e.g., leaf node). In other embodiments, the collectors 32 may be located near an end-of-row switch. In certain embodiments, one or more of the leaf nodes 14a, 14b, 14c, 14d may each have an associated collector 32. For example, if the leaf node is a top-of-rack switch, then each rack may contain an assigned collector 32. The system may include any number of collectors 32 (e.g., one or more).

The analytics module 30 is configured to receive and process network traffic data collected by collectors 32 and detected by sensors 26 placed on nodes located throughout the network. The analytics module 30 may be, for example, a standalone network appliance or implemented as a VM image that can be distributed onto a VM, cluster of VMs, Software as a Service (SaaS), or other suitable distribution model. The analytics module 30 may also be located at one of the endpoints or other network device, or distributed among one or more network devices.

In certain embodiments, the analytics module 30 may be implemented in an active-standby model to ensure high availability, with a first analytics module functioning in a primary role and a second analytics module functioning in a secondary role. If the first analytics module fails, the second analytics module can take over control.

As shown in FIG. 1, the analytics module 30 includes an anomaly detector 34. The anomaly detector 34 may operate at any computer or network device (e.g., server, controller, appliance, management station, or other processing device or network element) operable to receive network performance data and, based on the received information, identify features in which an anomaly deviates from other features. The anomaly detection module 34 may, for example, learn what causes security violations by monitoring and analyzing behavior and events that occur prior to the security violation taking place, in order to prevent such events from occurring in the future.

Computer networks may be exposed to a variety of different attacks that expose vulnerabilities of computer systems in order to compromise their security. For example, network traffic transmitted on networks may be associated with malicious programs or devices. The anomaly detection module 34 may be provided with examples of network states corresponding to an attack and network states corresponding to normal operation. The anomaly detection module 34 can then analyze network traffic flow data to recognize when the network is under attack. In some example embodiments, the network may operate within a trusted environment for a period of time so that the anomaly detector 34 can establish a baseline normalcy. The analytics module 30 may include a database or norms and expectations for various components. The database may incorporate data from external sources. In certain embodiments, the analytics module 30 may use machine learning techniques to identify security threats to a network using the anomaly detection module 34. Since malware is constantly evolving and changing, machine learning may be used to dynamically update models that are used to identify malicious traffic patterns. Machine learning algorithms are used to provide for the identification of anomalies within the network traffic based on dynamic modeling of network behavior.

The anomaly detection module 34 may be used to identify observations which differ from other examples in a dataset. For example, if a training set of example data with known outlier labels exists, supervised anomaly detection techniques may be used. Supervised anomaly detection techniques utilize data sets that have been labeled as “normal” and “abnormal” and train a classifier. In a case in which it is unknown whether examples in the training data are outliers, unsupervised anomaly techniques may be used. Unsupervised anomaly detection techniques may be used to detect anomalies in an unlabeled test data set under the assumption that the majority of instances in the data set are normal by looking for instances that seem to fit to the remainder of the data set.

In one embodiment, machine learning based network anomaly detection may be based on the use of honeypots 35. The honeypot 35 may be a virtual machine (VM) in which there is no expected network traffic to be associated therewith. For example, the honeypot 35 may be added within a network with no legitimate purpose. As a result, any traffic observed associated with this virtual machine is by definition, suspicious. For simplification, only one honeypot 35 is shown in the network of FIG. 1, however, the network may include any number of honeypots at various locations within the network. An example of machine learning based anomaly detection with honeypots 35 is described further below. As described below, the honeypot 35 may be used to collect labeled malicious network traffic for use as an input to unsupervised and supervised machine learning techniques.

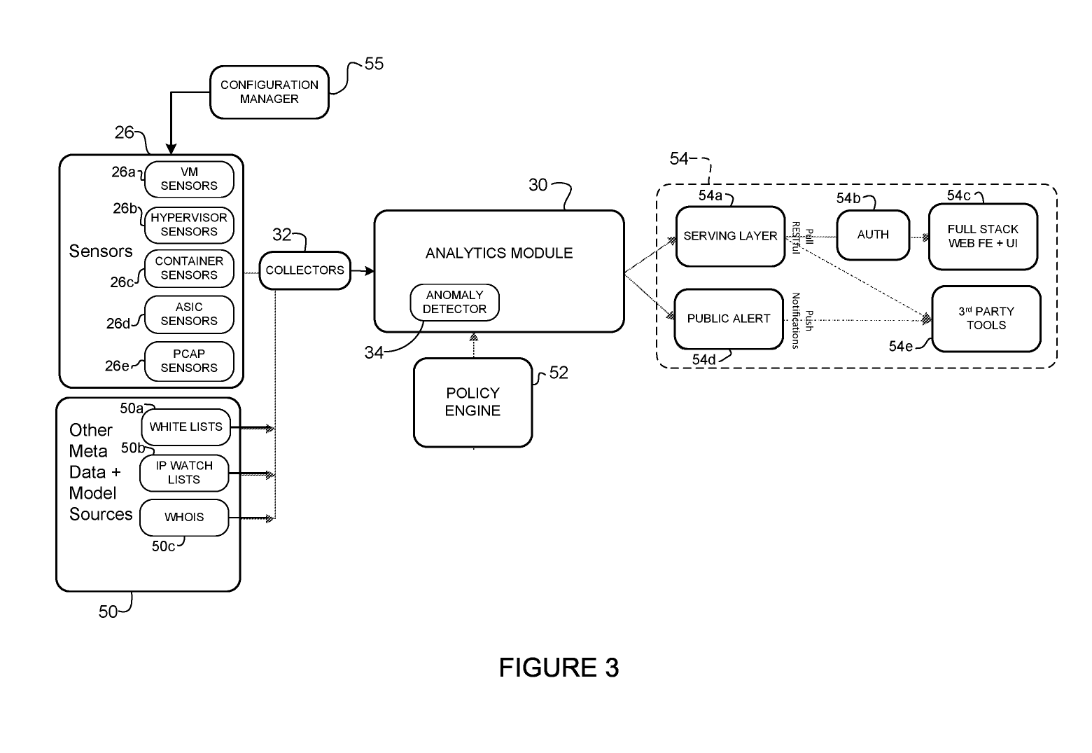

In certain embodiments, the analytics module 30 may determine dependencies of components within the network using an application dependency module, described further below with respect to FIG. 3. For example, if a first component routinely sends data to a second component but the second component never sends data to the first component, then the analytics module 30 can determine that the second component is dependent on the first component, but the first component is likely not dependent on the second component. If, however, the second component also sends data to the first component, then they are likely interdependent. These components may be processes, virtual machines, hypervisors, VLANs, etc. Once analytics module 30 has determined component dependencies, it can then form a component (application) dependency map. This map may be instructive when analytics module 30 attempts to determine a root cause of failure (e.g., failure of one component may cascade and cause failure of its dependent components). This map may also assist analytics module 30 when attempting to predict what will happen if a component is taken offline.

The analytics module 30 may establish patterns and norms for component behavior. For example, it can determine that certain processes (when functioning normally) will only send a certain amount of traffic to a certain VM using a small set of ports. The analytics module 30 may establish these norms by analyzing individual components or by analyzing data coming from similar components (e.g., VMs with similar configurations). Similarly, analytics module 30 may determine expectations for network operations. For example, it may determine the expected latency between two components, the expected throughput of a component, response times of a component, typical packet sizes, traffic flow signatures, etc. The analytics module 30 may combine its dependency map with pattern analysis to create reaction expectations. For example, if traffic increases with one component, other components may predictability increase traffic in response (or latency, compute time, etc.).

The analytics module 30 may also be used to address policy usage (e.g., how effective is each rule, can a rule be deleted), policy violations (e.g., who is violating, what is being violated), policy compliance/audit (e.g., is policy actually applied), policy “what ifs”, policy suggestion, etc. In one embodiment, the analytics module 30 may also discover applications or select machines on which to discover applications, and then run application dependency algorithms. The analytics module 30 may then visualize and evaluate the data, and publish policies for simulation. The analytics module may be used to explore policy ramifications (e.g., add whitelists). The policies may then be published to a policy controller and real time compliance monitored. Once the policies are published, real time compliance reports may be generated. These may be used to select application dependency targets and side information.

It is to be understood that the network devices and topology shown in FIG. 1 and described above is only an example and the embodiments described herein may be implemented in networks comprising different network topologies or network devices, or using different protocols, without departing from the scope of the embodiments. For example, although network fabric 10 is illustrated and described herein as a leaf-spine architecture, the embodiments may be implemented based on any network topology, including any data center or cloud network fabric. The embodiments described herein may be implemented, for example, in other topologies including three-tier (e.g., core, aggregation, and access levels), fat tree, mesh, bus, hub and spoke, etc. The sensors 26 and collectors 32 may be placed throughout the network as appropriate according to various architectures. The network may include any number or type of network devices that facilitate passage of data over the network (e.g., routers, switches, gateways, controllers, appliances), network elements that operate as endpoints or hosts (e.g., servers, virtual machines, clients), and any number of network sites or domains in communication with any number of networks.

Moreover, the topology illustrated in FIG. 1 and described above is readily scalable and may accommodate a large number of components, as well as more complicated arrangements and configurations. For example, the network may include any number of fabrics 10, which may be geographically dispersed or located in the same geographic area. Thus, network nodes may be used in any suitable network topology, which may include any number of servers, virtual machines, switches, routers, appliances, controllers, gateways, or other nodes interconnected to form a large and complex network, which may include cloud or fog computing. Nodes may be coupled to other nodes or networks through one or more interfaces employing any suitable wired or wireless connection, which provides a viable pathway for electronic communications.

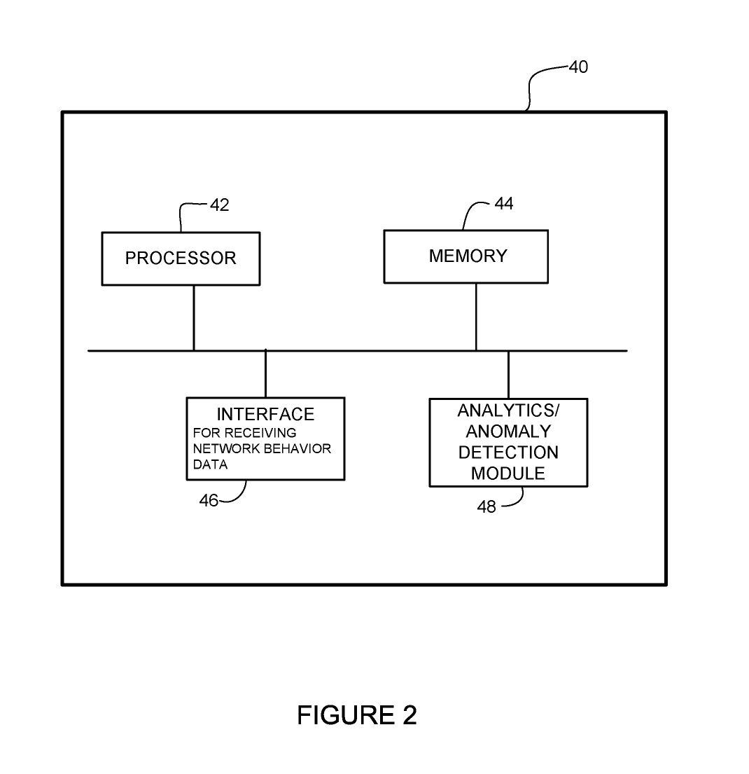

FIG. 2 illustrates an example of a network device 40 that may be used to implement the embodiments described herein. In one embodiment, the network device 40 is a programmable machine that may be implemented in hardware, software, or any combination thereof. The network device 40 includes one or more processor 42, memory 44, network interface 46, and analytics/anomaly detection module 48 (analytics module 30, anomaly detector 34 shown in FIG. 1).

Memory 44 may be a volatile memory or non-volatile storage, which stores various applications, operating systems, modules, and data for execution and use by the processor 42. For example, analytics/anomaly detection components (e.g., module, code, logic, software, firmware, etc.) may be stored in memory 44. The device may include any number of memory components.

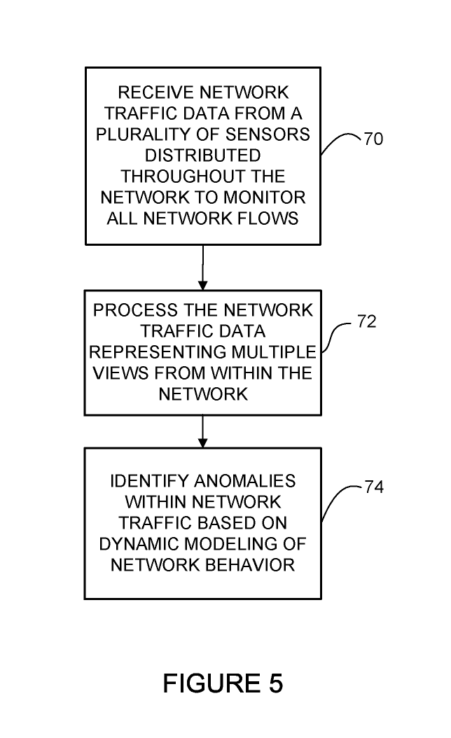

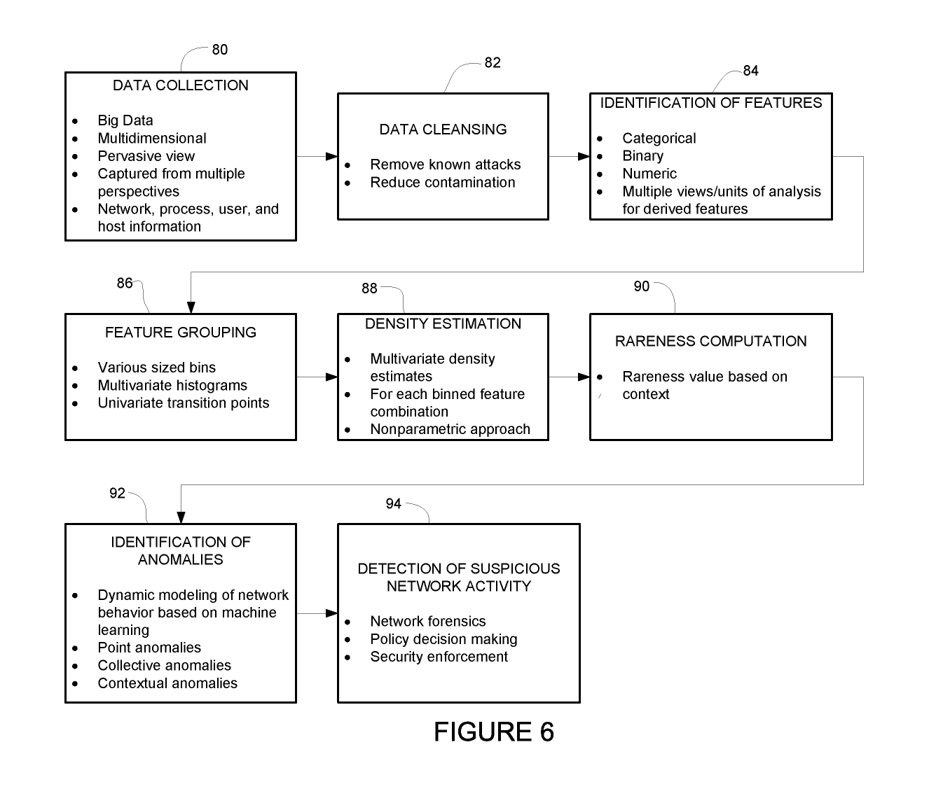

Logic may be encoded in one or more tangible media for execution by the processor 42. For example, the processor 42 may execute codes stored in a computer-readable medium such as memory 44 to perform the processes described below with respect to FIGS. 5 and 6. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium. The network device may include any number of processors 42. In one example, the computer-readable medium comprises a non-transitory computer-readable medium.

The network interface 46 may comprise any number of interfaces (linecards, ports) for receiving data or transmitting data to other devices. The network interface 46 may include, for example, an Ethernet interface for connection to a computer or network. As shown in FIG. 1 and described above, the interface 46 may be configured to receive traffic data collected from a plurality of sensors 26 distributed throughout the network. The network interface 46 may be configured to transmit or receive data using a variety of different communication protocols. The interface may include mechanical, electrical, and signaling circuitry for communicating data over physical links coupled to the network. The network device 40 may further include any number of input or output devices.

It is to be understood that the network device 40 shown in FIG. 2 and described above is only an example and that different configurations of network devices may be used. For example, the network device 40 may further include any suitable combination of hardware, software, processors, devices, components, modules, or elements operable to facilitate the capabilities described herein.

FIG. 3 illustrates an example of a network behavior data collection and analytics system in accordance with one embodiment. The system may include sensors 26, collectors 32, and analytics module (engine) 30 described above with respect to FIG. 1. In the example shown in FIG. 3, the system further includes external data sources 50, policy engine 52, and presentation module 54. The analytics module 30 receives input from the sensors 26 via collectors 32 and from external data sources 50, while also interacting with the policy engine 52, which may receive input from a network/security policy controller (not shown). The analytics module 30 may provide input (e.g., via pull or push notifications) to a user interface or third party tools, via presentation module 54, for example.

In one embodiment, the sensors 26 may be provisioned and maintained by a configuration and image manager 55. For example, when a new virtual machine 18 is instantiated or when an existing VM migrates, configuration manager 55 may provision and configure a new sensor 26 on the VM (FIGS. 1 and 3).

As previously described, the sensors 26 may reside on nodes of a data center network. One or more of the sensors 26 may comprise, for example, software (e.g., piece of software running (residing) on a virtual partition, which may be an instance of a VM (VM sensor 26a), hypervisor (hypervisor sensor 26b), sandbox, container (container sensor 26c), virtual switch, physical server, or any other environment in which software is operating). The sensor 26 may also comprise an application-specific integrated circuit (ASIC) (ASIC sensor 26d) (e.g., component of a switch, gateway, router, standalone packet monitor, or other network device including a packet capture (PCAP) module (PCAP sensor 26e) or similar technology), or an independent unit (e.g., device connected to a network device's monitoring port or a device connected in series along a main trunk (link, path) of a data center).

The sensors 26 may send their records over a high-speed connection to one or more of the collectors 32 for storage. In certain embodiments, one or more collectors 32 may receive data from external data sources 50 (e.g., whitelists 50a, IP watch lists 50b, Who is data 50c, or out-of-band data. In one or more embodiments, the system may comprise a wide bandwidth connection between collectors 32 and analytics module 30.

As described above, the analytics module 30 comprises an anomaly detection module 34, which may use machine learning techniques to identify security threats to a network. Anomaly detection module 34 may include examples of network states corresponding to an attack and network states corresponding to normal operation. The anomaly detection module 34 can then analyze network traffic flow data to recognize when the network is under attack. The analytics module 30 may store norms and expectations for various components in a database, which may also incorporate data from external sources 50. Analytics module 30 may then create access policies for how components can interact using policy engine 52. Policies may also be established external to the system and the policy engine 52 may incorporate them into the analytics module 30.

The presentation module 54 provides an external interface for the system and may include, for example, a serving layer 54a, authentication module 54b, web front end and UI (User Interface) 54c, public alert module 54d, and third party tools 54e. The presentation module 54 may preprocess, summarize, filter, or organize data for external presentation.

The serving layer 54a may operate as the interface between presentation module 54 and the analytics module 30. The presentation module 54 may be used to generate a webpage. The web front end 54c may, for example, connect with the serving layer 54a to present data from the serving layer in a webpage comprising bar charts, core charts, tree maps, acyclic dependency maps, line graphs, tables, and the like.

The public alert module 54d may use analytic data generated or accessible through analytics module 30 and identify network conditions that satisfy specified criteria and push alerts to the third party tools 54e. One example of a third party tool 54e is a Security Information and Event Management (SIEM) system. Third party tools 54e may retrieve information from serving layer 54a through an API (Application Programming Interface) and present the information according to the SIEM's user interface, for example.

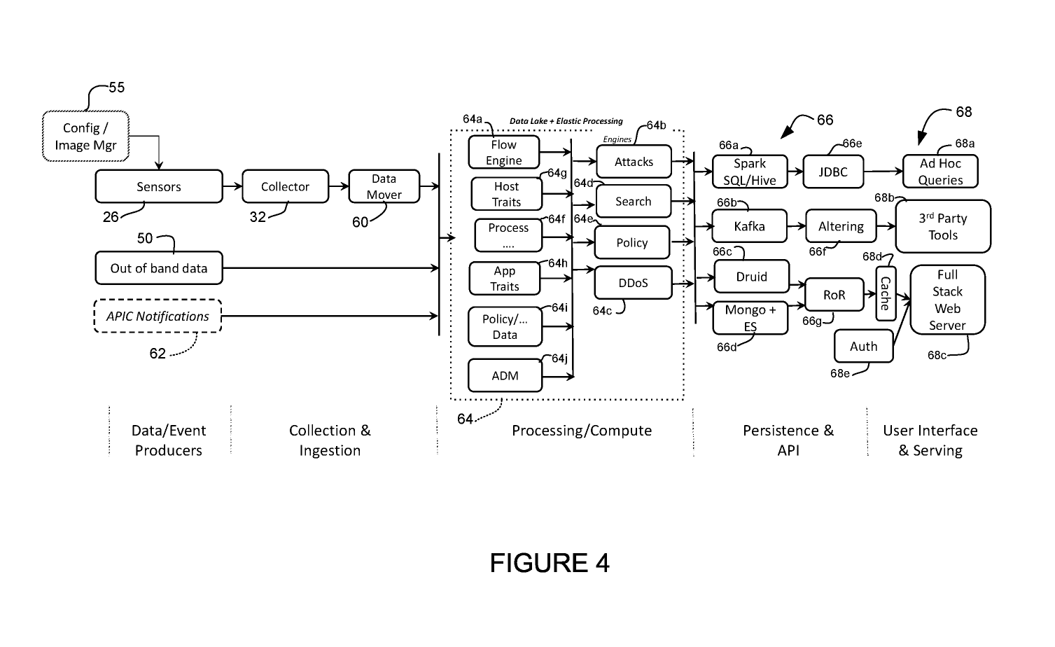

FIG. 4 illustrates an example of a data processing architecture of the network behavior data collection and analytics system shown in FIG. 3, in accordance with one embodiment. As previously described, the system includes a configuration/image manager 55 that may be used to configure or manage the sensors 26, which provide data to one or more collectors 32. A data mover 60 transmits data from the collector 32 to one or more processing engines 64. The processing engine 64 may also receive out of band data 50 or APIC (Application Policy Infrastructure Controller) notifications 62. Data may be received and processed at a data lake or other storage repository. The data lake may be configured, for example, to store 275 Tbytes (or more or less) of raw data. The system may include any number of engines, including for example, engines for identifying flows (flow engine 64a) or attacks including DDoS (Distributed Denial of Service) attacks (attack engine 64b, DDoS engine 64c). The system may further include a search engine 64d and policy engine 64e. The search engine 64d may be configured, for example to perform a structured search, an NLP (Natural Language Processing) search, or a visual search. Data may be provided to the engines from one or more processing components.

The processing/compute engine 64 may further include processing component 64f operable, for example, to identify host traits 64g and application traits 64h and to perform application dependency mapping (ADM 64j). The DDoS engine 64c may generate models online while the ADM 64j generates models offline, for example. In one embodiment, the processing engine is a horizontally scalable system that includes predefined static behavior rules. The compute engine may receive data from one or more policy/data processing components 64i.

The traffic monitoring system may further include a persistence and API (Application Programming Interface) portion, generally indicated at 66. This portion of the system may include various database programs and access protocols (e.g., Spark, Hive, SQL (Structured Query Language) 66a, Kafka 66b, Druid 66c, Mongo 66d), which interface with database programs (e.g. JDBC (JAVA Database Connectivity) 66e, altering 66f, RoR (Ruby on Rails) 66g). These or other applications may be used to identify, organize, summarize, or present data for use at the user interface and serving components, generally indicated at 68, and described above with respect to FIG. 3. User interface and serving segment 68 may include various interfaces, including for example, ad hoc queries 68a, third party tools 68b, and full stack web server 68c, which may receive input from cache 68d and authentication module 68e.

It is to be understood that the system and architecture shown in FIGS. 3 and 4, and described above is only an example and that the system may include any number or type of components (e.g., data bases, processes, applications, modules, engines, interfaces) arranged in various configurations or architectures, without departing from the scope of the embodiments. For example, sensors 26 and collectors 32 may belong to one hardware or software module or multiple separate modules. Other modules may also be combined into fewer components or further divided into more components.

FIG. 5 is a flowchart illustrating an overview of a process for anomaly detection with a pervasive view of network behavior, in accordance with one embodiment. At step 70, the analytics module 30 receives network traffic data collected from a plurality of sensors 26 distributed throughout the network and positioned within network components to obtain data from packets transmitted to and from the network components and monitor all network flows within the network from multiple perspectives in the network (FIGS. 1 and 5). The collected network traffic data is processed at the analytics module (step 72). The network traffic data includes process information, user information, and host information. Anomalies within the network are identified based on dynamic modeling of network behavior (step 74). For example, machine learning algorithms may be used to continuously update models of normal network behavior for use in identifying anomalies and possibly malicious network behaviors.

FIG. 6 illustrates an overview of a process flow for anomaly detection, in accordance with one embodiment. As described above with respect to FIG. 1, the data is collected at sensors 26 located throughout the network to monitor all packets passing through the network (step 80). The data may comprise, for example, raw flow data. The data collected may be big data (i.e., comprising large data sets having different types of data) and may be multidimensional. The data is captured from multiple perspectives within the network to provide a pervasive network view. The data collected includes network information, process information, user information, and host information.

In one or more embodiments the data source undergoes cleansing and processing at step 82. In data cleansing, rule-based algorithms may be applied and known attacks removed from the data for input to anomaly detection. This may be done to reduce contamination of density estimates from known malicious activity, for example.

Features are identified (derived, generated) for the data at step 84. The collected data may comprise any number of features. Features may be expressed, for example, as vectors, arrays, tables, columns, graphs, or any other representation. The network metadata features may be mixed and involve categorical, binary, and numeric features, for example. The feature distributions may be irregular and exhibit spikiness and pockets of sparsity. The scales may differ, features may not be independent, and may exhibit irregular relationships. The embodiments described herein provide an anomaly detection system appropriate for data with these characteristics. As described below, a nonparametric, scalable method is defined for identifying network traffic anomalies in multidimensional data with many features.

The raw features may be used to derive consolidated signals. For example, from the flow level data, the average bytes per packet may be calculated for each flow direction. The forward to reverse byte ratio and packet ratio may also be computed. Additionally, forward and reverse TCP flags (such as SYN (synchronize), PSH (push), FIN (finish), etc.) may be categorized as both missing, both zero, both one, both greater than one, only forward, and only reverse. Derived logarithmic transformations may be produced for many of the numeric (right skewed) features. Feature sets may also be derived for different levels of analysis.

In certain embodiments discrete numeric features (e.g., byte count and packet count) are placed into bins of varying size (step 86). Univariate transition points may be used so that bin ranges are defined by changes in the observed data. In one example, a statistical test may be used to identify meaningful transition points in the distribution.

In one or more embodiments, anomaly detection may be based on the cumulative probability of time series binned multivariate feature density estimates (step 88). In one example, a density may be computed for each binned feature combination to provide time series binned feature density estimates. Anomalies may be identified using nonparametric multivariate density estimation. The estimate of multivariate density may be generated based on historical frequencies of the discretized feature combinations. This provides increased data visibility and understandability, assists in outlier investigation and forensics, and provides building blocks for other potential metrics, views, queries, and experiment inputs.

Rareness may then be calculated based on cumulative probability of regions with equal or smaller density (step 90). Rareness may be determined based on an ordering of densities of multivariate cells. In one example, binned feature combinations with the lowest density correspond to the most rare regions. In one or more embodiments, a higher weight may be assigned to more recently observed data and a rareness value computed based on cumulative probability of regions with equal or smaller density. Instead of computing a rareness value for each observation compared to all other observations, a rareness value may be computed based on particular contexts.

New observations with a historically rare combination of features may be labeled as anomalies whereas new observations that correspond to a commonly observed combination of features are not (step 92). The anomalies may include, for example, point anomalies, contextual anomalies, and collective anomalies. Point anomalies are observations that are anomalous with respect to the rest of the data. Contextual anomalies are anomalous with respect to a particular context (or subset of the data). A collective anomaly is a set of observations that are anomalous with respect to the data. All of these types of anomalies are applicable to identifying suspicious activity in network data. In one embodiment, contextual anomalies are defined using members of the same identifier group.

The identified anomalies may be used to detect suspicious network activity potentially indicative of malicious behavior (step 94). The identified anomalies may be used for downstream purposes including network forensics, policy generation, and enforcement. For example, one or more embodiments may be used to automatically generate optimal signatures, which can then be quickly propagated to help contain the spread of a malware family.

It is to be understood that the processes shown in FIGS. 5 and 6 and described above are only examples and that steps may be added, combined, removed, or modified without departing from the scope of the embodiments.

As described above, one or more embodiments may use machine learning. Machine learning is an area of computer science in which the goal is to develop models using example observations (training data), that can be used to make predictions on new observations. In one embodiment, machine learning based network anomaly detection may be based on the use of honeypots 35 (FIG. 1). The models or logic are not based on theory, but rather are empirically based or data-driven. The honeypot 35 may be used to obtain labeled data for input to machine learning algorithms.

As previously noted, with supervised learning the training data examples contain labels for the outcome variable of interest. There are example inputs and the values of the outcome variable of interest are known in the training data. The goal of supervised learning is to learn a method for mapping inputs to the outcome of interest. The supervised models then make predictions about the values of the outcome variable for new observations. Supervised machine learning algorithms use a source of labeled training data. However, known malicious network data can be difficult or time consuming to obtain.

The honeypot 35 may be used to obtain labeled data for input to machine learning algorithms. As described above with respect to FIG. 1, the honeypot 35 may be a virtual machine (VM) in which there is no expected network traffic to be associated therewith. For example, the honeypot 35 may be added within a network with no legitimate purpose. As a result, any traffic observed associated with this virtual machine is by definition, suspicious. This is a method for obtaining known malicious data as a data source input to supervised machine learning classifiers.

In the context of a network data collection engine, most of the flow data is unlabeled. That is, for most flows, it is unknown whether the traffic is an attack or benign. The goal is to label each flow as suspicious or not. However, it can be very difficult to gather any labeled data, offline or through any means. Labeled (especially representative) data is quite valuable as supervised machine learning can be quite predictive.

Once a sizable amount of data is collected that is associated with the virtual machine, it may be used as training data with a suspicious label. Data collected that is not associated with the honeypot 35 (and not otherwise identified as malicious) is used to represent benign training data. A variety of supervised learning techniques (e.g., logistic regression, SVM (Support Vector Machine), decision trees, etc.) may then be applied to identify these two classes (benign/malicious) based on the flow metadata features. Feature patterns that distinguish these classes are then used to classify new flows (not associated with the honeypot) as likely suspicious or benign.

In unsupervised learning, there are example inputs, however, no outcome values. The goal of unsupervised learning can be to find patterns in the data or predict a desired outcome. Clustering and other unsupervised machine learning techniques may be used to identify different types of suspicious traffic observed and associated with the honeypot 35. The honeypot data provides a rich source of suspicious data from which forensics produce insight and understanding of various types of malicious activity.

As can be observed from the foregoing, the embodiments described herein provide numerous advantages. For example, the anomaly detection system provides a big data analytics platform that may be used to monitor everything (e.g., all packets, all network flows) from multiple vantage points to provide a pervasive view of network behavior. The comprehensive and pervasive information about network behavior may be collected over time and stored in a central location to enable the use of machine learning algorithms to detect suspicious activity. One or more embodiments may provide increased data visibility from host, process, and user perspectives and increased understandability. Certain embodiments may be used to assist in outlier investigation and forensics and provide building blocks for other potential metrics, view, queries, or experimental inputs.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving at an analytics module operating at a network device, network traffic data collected from a plurality of sensors distributed throughout a network and installed in network components to obtain the network traffic data from packets transmitted to and from the network components and monitor network flows within the network from multiple perspectives in the network;
processing the network traffic data at the analytics module, the network traffic data comprising process information, user information, and host information; and
identifying at the analytics module, anomalies within the network traffic data based on dynamic modeling of network behavior.

2. The method of claim 1 wherein processing the network traffic data comprises correlating said network behavior from said multiple perspectives in the network.

3. The method of claim 1 wherein the network device comprises a processor for examining big data comprising large data sets having different types of data.

4. The method of claim 1 wherein the network traffic data comprises metadata from each packet passing through one of said plurality of sensors.

5. The method of claim 1 wherein identifying said anomalies comprises identifying said anomalies in multidimensional data comprising a plurality of features.

6. The method of claim 1 wherein identifying said anomalies based on dynamic models of network behavior comprises utilizing machine learning algorithms to detect suspicious activity.

7. The method of claim 6 further comprising receiving data from a honeypot for use in machine learning.

8. The method of claim 1 further comprising generating an application dependency map for use in identifying said anomalies.

9. The method of claim 1 wherein identifying said anomalies comprises computing a nonparametric multivariate density estimation.

10. An apparatus comprising:
an interface for receiving network traffic data collected from a plurality of sensors distributed throughout a network and installed in network components to obtain the network traffic data from packets transmitted to and from the network components and monitor network flows within the network from multiple perspectives in the network; and
a processor for processing the network traffic data, the network traffic data comprising process information, user information, and host information, and identifying at the network device, anomalies within the network traffic data based on dynamic modeling of network behavior.

11. The apparatus of claim 10 wherein processing the network traffic data comprises correlating said network behavior from said multiple perspectives in the network.

12. The apparatus of claim 10 wherein the processor is operable to examine big data comprising large data sets having different types of data.

13. The apparatus of claim 10 wherein the network traffic data comprises metadata from each packet passing through one of said plurality of sensors.

14. The apparatus of claim 10 further comprising a distributed denial of service detector.

15. The apparatus of claim 10 wherein identifying said anomalies based on dynamic models of network behavior comprises utilizing machine learning algorithms to detect suspicious activity.

16. The apparatus of claim 10 wherein the processor is further configured to generate an application dependency map for use in identifying said anomalies.

17. Logic encoded on one or more non-transitory computer readable media for execution and when executed operable to:
process network traffic data collected from a plurality of sensors distributed throughout a network and installed in network components to obtain the network traffic data from packets transmitted to and from the network components and monitor network flows within the network from multiple perspectives in the network, the network traffic data comprising process information, user information, and host information; and
identify anomalies within the network traffic based on dynamic modeling of network behavior.

18. The logic of claim 17 wherein the logic is further operable to correlate said network behavior from said multiple perspectives to identify said anomalies.

19. The logic of claim 17 wherein machine learning algorithms receiving data from honeypots are utilized to detect suspicious activity.

20. The logic of claim 17 wherein said anomalies are identified by computing a nonparametric multivariate density estimation.
